(19) United States
(12) Patent Application Publication
(10) Pub. No.: US 2024/0297374 A1
(43) Pub. Date: Sep. 5, 2024

(54) INSULATION HOLDER AND ELECTRICITY STORAGE DEVICE

(71) Applicant: Prime Planet Energy & Solutions, Inc., Tokyo (JP)

(72) Inventor: Katsuya SHIKATA, Nisshin-shi (JP)

(21) Appl. No.: 18/440,966

(22) Filed: Feb. 14, 2024

(30) Foreign Application Priority Data
Mar. 3, 2023 (JP) 2023-032887

(51) Int. Cl. H01M 50/103; H01M 50/133; H01M 50/184

(52) U.S. Cl. CPC H01M 50/103; H01M 50/133; H01M 50/184

(57) ABSTRACT

An insulation holder disclosed herein is an insulating box-shaped body to house an electrode body of an electricity storage device. The insulation holder includes: a bottom face having a rectangular shape in a plan view; a pair of first side faces extending upward from the bottom face; and a pair of second side faces extending upward from the bottom face. The insulation holder is provided on its bottom side with corners. The corners are included in areas defined in the insulation holder. The areas are provided with thin portions.

### CROSS REFERENCE TO RELATED APPLICATIONS

This application claims the benefit of priority to Japanese Patent Application No. 2023-032887 filed on Mar. 3, 2023. The entire contents of this application are hereby incorporated herein by reference.

### BACKGROUND

### 1. Technical Field

The present disclosure relates to insulation holders and electricity storage devices including the insulation holders.

### 2. Description of the Related Art

Electricity storage devices, such as lithium ion secondary batteries, are used in various fields. Such an electricity storage device includes: an electrode body serving as a power generation element; a metallic case housing the electrode body; and an insulation holder located between the electrode body and the case. The case of the electricity storage device of this type includes: a box-shaped case body including an upper opening; and a sealing plate closing the upper opening. Manufacturing the electricity storage device first involves housing the electrode body in the insulation holder, which is an insulating box-shaped body. The electrode body covered with the insulation holder is then inserted into the case body through the upper opening. The upper opening of the case body is sealed with the sealing plate. This results in the electricity storage device in which the electrode body and the insulation holder are housed in the case.

An insulation holder for an electricity storage device is formed by folding a resin film. Prior art documents related to such an insulation holder include, for example, JP 2019-121496 A, JP 2020-095836 A, JP 2018-181435 A, JP 2017-091792 A, JP 2021-082464 A, JP 2020-104186 A, and JP 2019-110036 A. The manufacturing method described in JP 2019-121496 A, for example, includes: a preparing step involving preparing a film member subjected to a half-cutting process along predetermined folding lines; a long side folding step involving mountain-folding the film member along folding lines corresponding to long sides; a short side folding step involving mountain-folding the film member along folding lines corresponding to first short sides, and valley-folding the film member along folding lines corresponding to perpendicular lines; an oblique folding step involving mountain-folding the film member along folding lines corresponding to oblique lines; an assembling step involving inserting an electrode body into the film member thus folded; a covering step involving mountain-folding the film member along folding lines corresponding to second short sides such that the electrode body is covered with the film member; and a housing step involving housing the electrode body, which is covered with the film member, in a battery case.

### SUMMARY

The manufacturing method described above involves inserting the electrode body, which is covered with the folded film member (i.e., an insulation holder), into a case body of the battery case. Unfortunately, friction produced between the insulation holder and the case body during this insertion may lead to breakage of the insulation holder. If the electrode body is exposed as a result of the breakage of the insulation holder, the electrode body may be brought into conduction with the case. To solve this problem, manufacture of electricity storage devices may include the step of detecting whether an insulation holder is broken. Electricity storage devices whose insulation holders are determined to be broken will be discarded or recycled. Frequent breakage of insulation holders may disadvantageously lead to a significant reduction in production efficiency or yield.

Accordingly, embodiments of the present disclosure provide techniques for preventing or reducing breakage of insulation holders in inserting electrode bodies into case bodies.

An embodiment of the present disclosure provides an insulation holder that is an insulating box-shaped body to house an electrode body of an electricity storage device. The insulation holder includes: a bottom face having a rectangular shape in a plan view, the bottom face including a pair of first edges extending substantially in parallel with each other in a width direction, and a pair of second edges extending substantially in parallel with each other in a depth direction; a pair of first side faces each extending upward in a height direction from an associated one of the first edges; a pair of second side faces each extending upward in the height direction from an associated one of the second edges; four third edges each extending in the height direction along a boundary between an associated one of the first side faces and an associated one of the second side faces; and four corners each of which is an intersection of an associated one of the first edges, an associated one of the second edges, and an associated one of the third edges. Each of the four corners is included in an associated one of four areas defined in the insulation holder disclosed herein. At least one of the four areas is provided with a thin portion thinner than any other portion of the insulation holder.

When an insulation holder has a box shape and includes four corners in four corners of the bottom side of the insulation holder, the corners of the insulation holder are likely to interfere with a case body during insertion of the insulation holder into the case body, which may result in friction-induced breakage of the insulation holder. The insulation holder disclosed herein, however, is provided with the thin portion(s) in the area(s) including the corner(s). Thus, in the event of interference between the corner(s) of the insulation holder and a case body, the thin portion(s) including the corner(s) is/are crushed, which causes inward deformation of the corner(s) of the insulation holder. This eliminates interference between the corner(s) of the insulation holder and the case body, making it possible to prevent or reduce breakage of the insulation holder caused by friction between the insulation holder and the case body.

According to another embodiment of the present disclosure, the thin portion is provided in the bottom face, an associated one of the first side faces, and an associated one of the second side faces. Such an embodiment enables the thin portion(s) to be suitably provided around the corner(s) and thus facilitates inward deformation of the corner(s) of the insulation holder in the event of interference between the corner(s) and the case body.

According to still another embodiment of the present disclosure, the thin portion has a thickness of between 10 μm and 100 μm. Such an embodiment makes it possible to more suitably prevent or reduce breakage of the insulation holder.

According to yet another embodiment of the present disclosure, a shortest distance between the corner included in the at least one of the four areas and an outer edge of the thin portion is between 1 mm and 3 mm. Such an embodiment makes it possible to suitably prevent breakage of the electrode body and the insulation holder.

According to still yet another embodiment of the present disclosure, the thin portion is provided with a groove such that a region of the thin portion where the groove is provided is thinner than any other region of the thin portion. Such an embodiment causes bending of the insulation holder along the groove(s) and thus facilitates inward deformation of the corner(s) in the event of interference between the corner(s) of the insulation holder and the case body. This makes it possible to more suitably prevent or reduce breakage of the insulation holder caused by friction between the insulation holder and the case body.

Another embodiment of the present disclosure provides an electricity storage device. The electricity storage device disclosed herein includes: an electrode body; a case housing the electrode body; and an insulation holder located between the electrode body and the case. The case of the electricity storage device includes: a case body that is a box-shaped body including an upper opening; and a sealing plate closing the upper opening. The upper opening of the electricity storage device disclosed herein has a substantially rectangular shape in a plan view. The upper opening includes curved portions in four corners of the upper opening. The insulation holder of the electricity storage device disclosed herein is the insulation holder according to any one of the above embodiments. Such an embodiment makes it possible to prevent or reduce breakage of the insulation holder.

### BRIEF DESCRIPTION OF THE DRAWINGS

FIG. 1 is a schematic perspective view of an external appearance of a secondary battery according to an embodiment of the present disclosure.

FIG. 2 is a schematic vertical cross-sectional view of an internal structure of the secondary battery illustrated in FIG. 1.

FIG. 3 is a plan view of a case body illustrated in FIG. 1.

FIG. 4 is a schematic perspective view of an insulation holder according to the embodiment of the present disclosure.

FIG. 5 is an enlarged bottom perspective view of the insulation holder illustrated in FIG. 4.

FIG. 6 is a horizontal cross-sectional view of the secondary battery according to the embodiment of the present disclosure, illustrating the positional relationship between the case body and the insulation holder during manufacture of the secondary battery.

FIG. 7 is a plan view of a film to be folded into the insulation holder according to the embodiment of the present disclosure.

FIG. 8 is an enlarged plan view of a portion of the film illustrated in FIG. 7.

FIG. 9 is a horizontal cross-sectional view of a secondary battery according to another embodiment of the present disclosure, illustrating the positional relationship between a case body and an insulation holder during manufacture of the secondary battery.

FIG. 10 is a horizontal cross-sectional view of a conventional secondary battery, illustrating the positional relationship between a case body and an insulation holder during manufacture of the conventional secondary battery.

### DETAILED DESCRIPTION

Preferred embodiments of the present disclosure will be described below with reference to the drawings. Matters that are not specifically mentioned herein but are necessary for carrying out the present disclosure may be understood by those skilled in the art as design matters based on techniques known in the related art. The present disclosure may be carried out on the basis of the description given herein and common technical knowledge in the related art. Any range between “A” and “B” used herein (where A is a numerical value representing the lower limit of the range and B is a numerical value representing the upper limit of the range) may be inclusive of A and B, or may be greater than A and less than B.

As used herein, the term “electricity storage device” refers to any of various devices chargeable and dischargeable by movement of charge carriers between a pair of electrodes (i.e., a positive electrode and a negative electrode) through an electrolyte. Electricity storage devices according to the present disclosure may be secondary batteries (such as lithium ion secondary batteries, nickel-metal hydride batteries, and nickel-cadmium batteries) or may be capacitors (such as lithium ion capacitors and electric double layer capacitors).

### 1. Structure of Secondary Battery

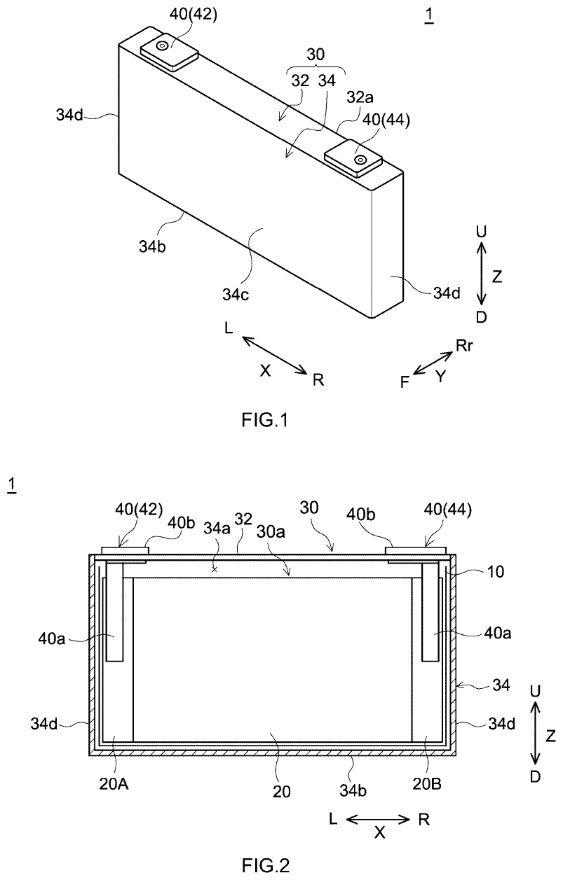

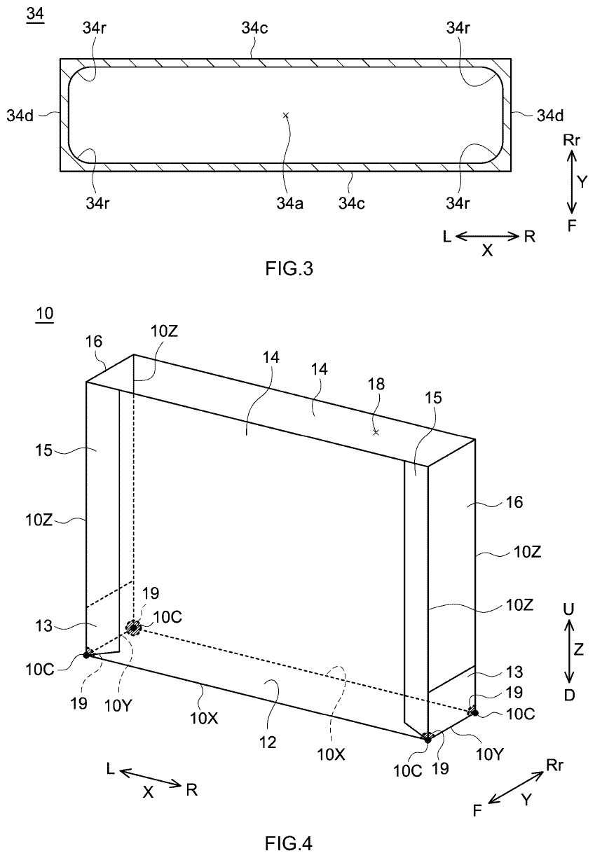

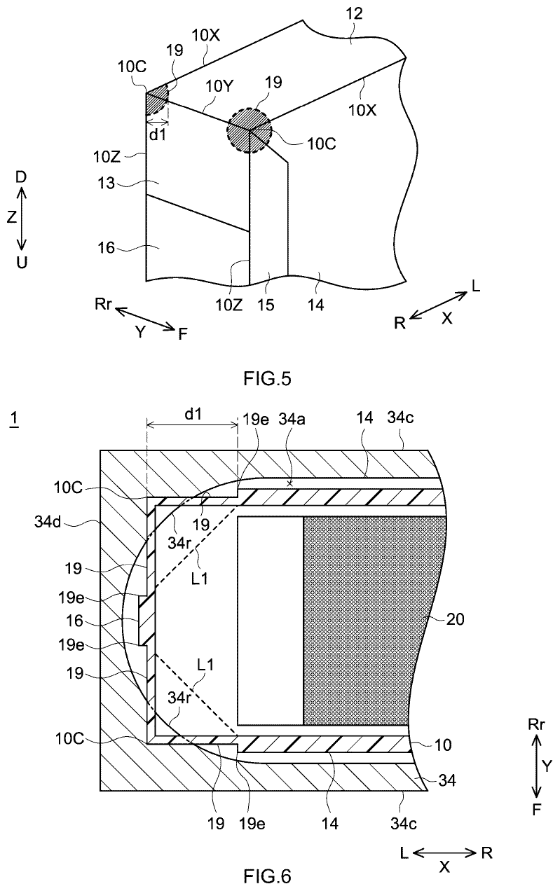

An embodiment of the present disclosure will be described below. The present embodiment provides a secondary battery including an insulation holder. FIG. 1 is a schematic perspective view of an external appearance of the secondary battery according to the present embodiment. FIG. 2 is a schematic vertical cross-sectional view of an internal structure of the secondary battery illustrated in FIG. 1. FIG. 3 is a plan view of a case body illustrated in FIG. 1. FIG. 4 is a schematic perspective view of the insulation holder according to the present embodiment. FIG. 5 is an enlarged bottom perspective view of the insulation holder illustrated in FIG. 4. FIG. 6 is a horizontal cross-sectional view of the secondary battery according to the present embodiment, illustrating the positional relationship between the case body and the insulation holder during manufacture of the secondary battery. The reference sign X in the drawings represents a width direction. The reference sign Y in the drawings represents a depth direction. The reference sign Z in the drawings represents a height direction. The reference signs L, R, F, Rr, U, and D in the drawings respectively represent left, right, front, rear, up, and down. These directions, however, are defined merely for the sake of convenience of description and do not limit how the insulation holder or the electricity storage device may be installed during use or manufacture.

As illustrated in FIGS. 1 and 2, a secondary battery 1 according to the present embodiment includes an electrode body 20, a case 30, and an insulation holder 10. The components of the secondary battery 1 will be described below.

### (1) Case

The case 30 is a flat box-shaped container including an internal space 30a. The electrode body 20 is housed in the internal space 30a of the case 30. The case 30 is preferably a metallic member whose strength is at or above a certain level. Examples of materials for the case 30 include metallic materials, such as aluminum and an aluminum alloy. The case 30 includes a case body 34 and a sealing plate 32.

### (a) Case Body

The case body 34 is a box-shaped body including an upper opening 34a. Specifically, the case body 34 includes: a bottom face 34b, which is a long rectangular plate member; a pair of first side walls 34c extending upward from the long sides of the bottom face 34b (which extend in the width direction X); and a pair of second side walls 34d extending upward from the short sides of the bottom face 34b (which extend in the depth direction Y). The first side walls 34c are larger in area than the second side walls 34d. In other words, the second side walls 34d are smaller in area than the first side walls 34c.

As illustrated in FIG. 3, the case body 34 is provided at its upper surface with the upper opening 34a having a rectangular shape in the plan view. The upper opening 34a is surrounded by the first side walls 34c and the second side walls 34d. Due to manufacture constrains, curved portions 34r are usually formed in four corners of the upper opening 34a of the case body 34. Specifically, fabrication of the case body 34 involves rolling an ingot of a metallic material. The case body 34 fabricated by rolling includes the bottom face 34b, the first side walls 34c, and the second side walls 34d, which are seamlessly integral with one another, and is thus able to prevent leakage of gas or an electrolytic solution from the boundaries between the surfaces of the walls. A metal material, however, has high rigidity. Thus, rolling such a metal material into the case body 34 makes it difficult for the inner surfaces of the walls (e.g., the first side walls 34c and the second side walls 34d) adjacent to each other to form right angles. In addition, the curved portions 34r have the function of reinforcing the boundaries between the first side walls 34c and the second side walls 34d. In view of these points, the curved portions 34r are usually formed in four corners of the upper opening 34a of the case body 34. The curved portions 34r of the upper opening 34a may have a curvature radius R of, for example, between about 2 mm and 3 mm. The curved portions 34r of the upper opening 34a, however, may have any other suitable curvature radius R.

### (b) Sealing Plate

The sealing plate 32 is a plate member to close the upper opening 34a of the case body 34. Specifically, the sealing plate 32 is fitted into the upper opening 34a of the case body 34 as illustrated in FIG. 2. Steps for manufacturing the secondary battery 1 include a laser welding step. The laser welding step involves applying laser to the sealing plate 32 and the upper surface of the case body 34 such that the laser straddles the boundary between the sealing plate 32 and the case body 34. The laser is applied to the entire outer peripheral edge of the sealing plate 32 (i.e., the entire inner peripheral edge of the case body 34). Performing the laser welding step in this manner hermetically seals the internal space 30a of the case 30.

The sealing plate 32 has a pair of electrode terminals 40 attached thereto. The electrode terminals 40 are conductive members electrically connected to the electrode body 20 located inside the case 30. The secondary battery 1 illustrated in FIG. 2 is provided with the pair of electrode terminals 40 located on the ends of the sealing plate 32 in the width direction X. One of the pair of electrode terminals 40 (i.e., the electrode terminal 40 located on the left end of the sealing plate 32 in FIG. 2) is a positive electrode terminal 42 connected to a positive electrode of the electrode body 20. The other one of the pair of electrode terminals 40 (i.e., the electrode terminal 40 located on the right end of the sealing plate 32 in FIG. 2) is a negative electrode terminal 44 connected to a negative electrode of the electrode body 20. As illustrated in FIG. 2, each of the electrode terminals 40 is a combination of conductive members (such as a collecting member 40a and an external terminal 40b) and extends in the height direction Z. Specifically, the collecting members 40a, which define the lower ends of the electrode terminals 40, are connected to the electrode body 20 inside the case 30. The external terminals 40b, which define the upper ends of the electrode terminals 40, are exposed outside the case 30. The collecting members 40a are each electrically connected to an associated one of the external terminals 40b through a shaft portion (not illustrated) passing through the sealing plate 32.

### (2) Electrode Body

As illustrated in FIG. 2, the electrode body 20 is housed in the case 30. In the present embodiment, the number of electrode bodies 20 housed in the case 30 is one. Alternatively, any number of electrode bodies 20 may be housed in the case 30. More than one electrode body 20 may be housed in the case 30. In one example, the electrode body 20 is provided by stacking positive and negative electrodes, with a separator interposed therebetween. The positive electrode includes: a positive electrode core (which is made of, for example, aluminum foil); and a positive electrode active material layer applied to a surface of the positive electrode core. The negative electrode includes: a negative electrode core (which is made of, for example, copper foil); and a negative electrode active material layer applied to a surface of the negative electrode core. Materials for the components of the electrode body 20 (such as the positive and negative electrodes and the separator) may be any materials usable for common secondary batteries and will thus not be described in detail.

A positive electrode connection 20A is provided on a first lateral edge of the electrode body 20 (which is illustrated in FIG. 2) in the width direction X. A negative electrode connection 20B is provided on a second lateral edge of the electrode body 20 in the width direction X. The positive electrode connection 20A is provided by bundling together portions of the positive electrode core to which no positive electrode active material layer is applied. The negative electrode connection 20B is provided by bundling together portions of the negative electrode core to which no negative electrode active material layer is applied. The positive electrode terminal 42 is connected to the positive electrode of the electrode body 20 through the positive electrode connection 20A. The negative electrode terminal 44 is connected to the negative electrode of the electrode body 20 through the negative electrode connection 20B.

In the secondary battery 1 according to the present embodiment, an electrolytic solution is permeated through the electrode body 20 (i.e., between the positive and negative electrodes). Components of the electrolytic solution may be any components usable for common secondary batteries and will thus not be described in detail. Some of the electrolytic solution may be present in the form of a redundant electrolytic solution outside the electrode body 20 (e.g., between the electrode body 20 and the case 30). The redundant electrolytic solution may thus be supplied to the inside of the electrode body 20 upon decomposition of the electrolytic solution inside the electrode body 20.

### (3) Insulation Holder

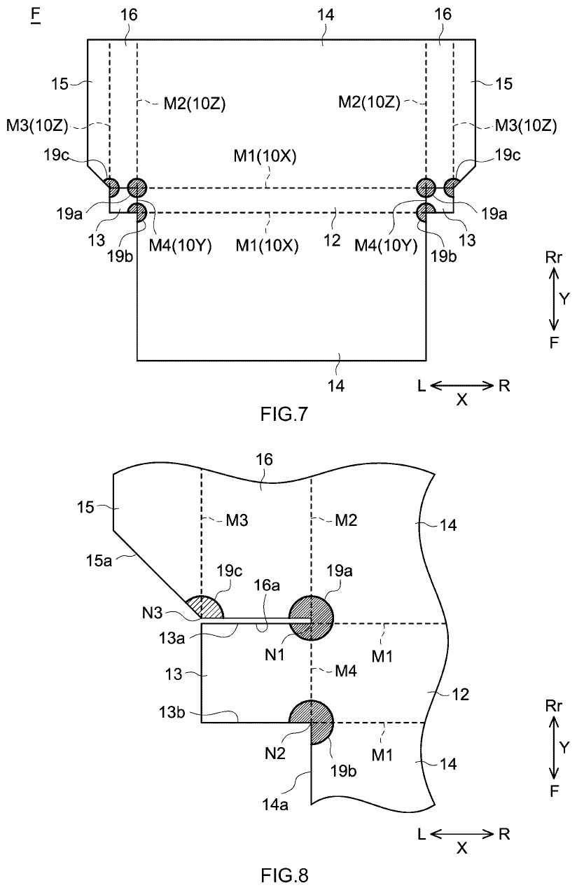

The insulation holder 10 is an insulating member covering the electrode body 20. The insulation holder 10 of the secondary battery 1 manufactured is located between the electrode body 20 and the case 30 (see FIGS. 2 and 6). The insulation holder 10 is thus able to prevent conduction between the case 30 and the electrode body 20. The insulation holder 10 according to the present embodiment is formed by folding a film F (see FIG. 7) made of an insulating material. A material for the insulation holder 10 may be any insulating material known in the related art. In view of material cost and formability, for example, the insulation holder 10 is preferably made of a resin material, such as polypropylene (PP) or polyethylene (PE). The insulation holder 10 preferably has a thickness of between 75 μm and 200 μm, and more preferably has a thickness of between 90 μm and 160 μm. The insulation holder 10 having such a thickness is easily formable and is able to deliver a high level of insulation performance.

As illustrated in FIG. 4, the insulation holder 10 according to the present embodiment is a box-shaped body including an internal space in which the electrode body 20 is to be housed. The structure of the insulation holder 10 will be described in detail below.

As illustrated in FIG. 4, the insulation holder 10 includes a bottom face 12. The bottom face 12 is a plate member having a rectangular shape in a plan view. The bottom face 12 includes: a pair of first edges 10X extending substantially in parallel with each other in the width direction X; and a pair of second edges 10Y extending substantially in parallel with each other in the depth direction Y. As used herein, the term “substantially in parallel with each other” refers to a situation where a pair of straight lines (or sides) form an angle of 0.15° or less, preferably form an angle of 0.1° or less, and more preferably form an angle of 0.05° or less. The smaller the angle formed by the pair of sides (i.e., the pair of first edges 10X or the pair of second edges 10Y), the smaller the differences in dimensions of the components during assembly of the insulation holder 10.

The insulation holder 10 further includes a pair of first side faces 14. Each of the pair of first side faces 14 is a rectangular plate member extending upward in the height direction Z from an associated one of the first edges 10X of the bottom face 12. The pair of first side faces 14 face each other, with the internal space (in which the electrode body 20 is to be housed) located therebetween (see FIG. 6). The insulation holder 10 further includes a pair of second side faces 16. Each of the pair of second side faces 16 is a rectangular plate member extending upward in the height direction Z from an associated one of the second edges 10Y of the bottom face 12. Similarly to the first side faces 14, the second side faces 16 face each other, with the internal space located therebetween. The insulation holder 10 is provided with third edges 10Z extending along the boundaries between the first side faces 14 and the second side faces 16. The third edges 10Z are four ridge lines extending in the height direction Z. The insulation holder 10 is provided at its upper surface with an opening 18. The opening 18 is surrounded by the first side faces 14 and the second side faces 16. When the electrode body 20 is housed in the internal space of the insulation holder 10, the electrode body 20 is inserted into the internal space through the opening 18.

The insulation holder 10 according to the present embodiment further includes first locking portions 15 and second locking portions 13. The first locking portions 15 and the second locking portions 13 are able to prevent the insulation holder 10 from unfolding during manufacture of the secondary battery 1. Specifically, the first locking portions 15 are plate members continuous with the third edges 10Z extending along the front edges of the second side faces 16. In other words, the first locking portions 15 extend in the height direction Z. The first locking portions 15 are folded so as to cover the lateral edges of the forwardly located first side face 14 in the width direction X. The first locking portions 15 folded in this manner are able to prevent the first side faces 14 from rotating (or unfolding) outward (e.g., forward or rearward) in the depth direction Y. The first locking portions 15 are preferably thermally welded to the forwardly located first side face 14. The first locking portions 15 in this case are able to more suitably prevent unfolding of the insulation holder 10.

The second locking portions 13 are a pair of plate members extending upward from the second edges 10Y of the bottom face 12. The second locking portions 13 are folded so as to cover the lower regions of the second side faces 16. The second locking portions 13 folded in this manner are able to prevent the second side faces 16 from rotating (or unfolding) rearward in the depth direction Y. The second locking portions 13 are also able to prevent or reduce defective insulation caused by gaps created in the borders (i.e., the second edges 10Y) between the bottom face 12 and the second side faces 16. The second locking portions 13 may be thermally welded to the second side faces 16. The second locking portions 13 in this case are able to more suitably prevent unfolding of the insulation holder 10. In view of manufacturing cost, however, the second locking portions 13 are preferably not thermally welded to the second side faces 16.

The insulation holder 10, which is a box-shaped body, is provided on its bottom side with four corners 10C. The corners 10C are each defined by the intersection of an associated one of the first edges 10X, an associated one of the second edges 10Y, and an associated one of the third edges 10Z. Each of the corners 10C is included in an associated one of four areas defined in the insulation holder 10 according to the present embodiment. The four areas are each provided with a thin portion 19 thinner than any other portion of the insulation holder 10. The thin portions 19 each have a circular or substantially circular shape. Providing the thin portions 19 makes it possible to prevent or reduce breakage of the insulation holder 10 caused by friction between the insulation holder 10 and the case body 34 during manufacturing process of the secondary battery 1. The following description discusses causes for breakage of an insulation holder of a conventional secondary battery, and then discusses the breakage preventing effect of the insulation holder 10 according to the present embodiment.

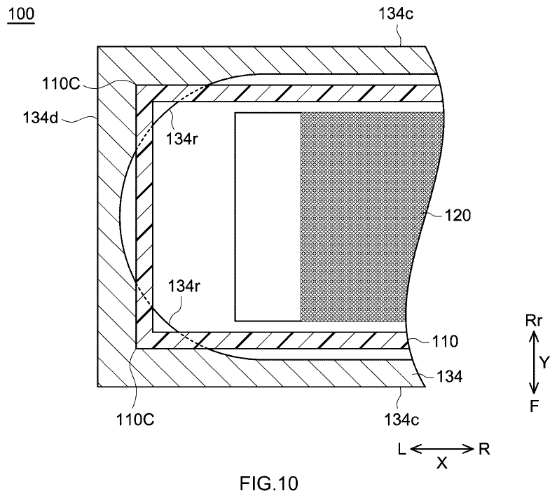

FIG. 10 is a horizontal cross-sectional view illustrating the positional relationship between a case body 134 and an insulation holder 110 during manufacture of the conventional secondary battery 100. Curved portions 134r are formed in four corners of an upper opening 134a of the case body 134. Corners 110C are formed on four corners of the bottom side of the insulation holder 110, which is a box-shaped body. From the viewpoint of enhancing battery performance, what is required is to design the dimensions of components of an electrode body 120 and the case body 134 such that the electrode body 120 is close to side walls (i.e., first side walls 134c and second side walls 134d) of the case body 134. When the insulation holder 110 is designed to house the electrode body 120 adjacent to the side walls of the case body 134, the corners 110C of the insulation holder 110 may be located outward of the curved portions 134r of the case body 134 in a plan view as illustrated in FIG. 10. In such a case, inserting the electrode body 120 into the upper opening 134a of the case body 134 causes interference between the corners 110C of the insulation holder 110 and the curved portions 134r of the case body 134. Inserting the electrode body 120 further into the upper opening 134a in this state results in breakage of the corners 110C of the insulation holder 110 caused by friction between the corners 110C and the case body 134.

To solve this problem, the insulation holder 10 according to the present embodiment is provided with the thin portions 19 in the areas including the corners 10C as illustrated in FIGS. 5 and 6. Thus, in the event of interference between the curved portions 34r of the case body 34 and the corners 10C of the insulation holder 10, the thin portions 19 are crushed, which causes the corners 10C to deform inward (i.e., toward the electrode body 20). This deformation eliminates interference between the corners 10C of the insulation holder 10 and the curved portions 34r of the case body 34, making it possible to prevent or reduce breakage of the corners 10C caused by friction between the corners 10C and the case body 34.

As illustrated in FIG. 5, the insulation holder 10 according to the present embodiment includes the thin portions 19 each provided in the bottom face 12, an associated one of the first side faces 14, and an associated one of the second side faces 16. This arrangement enables the thin portions 19 to be suitably provided around the corners 10C and thus facilitates inward deformation of the corners 10C of the insulation holder 10 in the event of interference between the curved portions 34r of the case body 34 and the corners 10C of the insulation holder 10.

The range in which the thin portions 19 are to be provided is preferably set in consideration of the dimensions of the curved portions 34r of the case body 34 and the electrode body 20. Specifically, the range in which the thin portions 19 are to be provided is preferably adjusted such that straight lines L1 (see FIG. 6), connecting outer edges 19e of the thin portions 19 in the first side faces 14 with outer edges 19e of the thin portions 19 in the second side face 16, are located outward of the electrode body 20 and inward of the curved portions 34r of the case body 34 in a plan view. Providing the thin portions 19 in this manner makes it possible to not only prevent or reduce breakage of the corners 10C caused by friction between the corners 10C and the case body 34, but also preclude breakage of the electrode body 20 caused by contact between the electrode body 20 and the insulation holder 10 (or the corners 10C) deformed. In one example, a shortest distance D1 between each corner 10C and the outer edge 19e of the thin portion 19 associated thereto is preferably 1 mm or more, and more preferably 1.5 mm or more. This results in an increase in the degree of deformation of the insulation holder 10, making it possible to suitably prevent or reduce breakage of the corners 10C caused by interference between the corners 10C and the curved portions 34r. The shortest distance D1 is preferably 3 mm or less, and more preferably 2.5 mm or less. This makes it possible to suitably preclude breakage of the electrode body 20 and the insulation holder 10.

The thickness of each thin portion 19 is preferably 100 μm or less, more preferably 90 μm or less, still more preferably 80 μm or less, and yet more preferably 70 μm or less. The smaller the thickness of each thin portion 19, the more likely it is that the thin portions 19 will be crushed in the event of interference between the corners 10C and the case body 34, making it possible to more suitably prevent breakage of the corners 10C caused by friction between the corners 10C and the case body 34. The thickness of each thin portion 19 is preferably 10 μm or more, more preferably 20 μm or more, still more preferably 30 μm or more, and yet more preferably 40 μm or more. This enables the thin portions 19 to have sufficient strength, making it possible to prevent breakage of the thin portions 19.

### 2. Method for Manufacturing Insulation Holder

The following description discusses a method for manufacturing the insulation holder 10 according to the present embodiment. FIG. 7 is a plan view of the film F to be folded into the insulation holder 10 according to the present embodiment. FIG. 8 is an enlarged view of a portion of the film F illustrated in FIG. 7.

Manufacturing the insulation holder 10 according to the present embodiment first involves preparing the film F illustrated in FIG. 7. As illustrated in FIG. 7, the film F includes a bottom face 12, a pair of first side faces 14, a pair of second side faces 16, first locking portions 15, and second locking portions 13. The bottom face 12 has a rectangular shape in the plan view. The first side faces 14 each have a rectangular shape in the plan view and each extend from an associated one of the lateral edges of the bottom face 12 in the depth direction Y. The second side faces 16 each have a rectangular shape in the plan view and each extend from an associated one of the lateral edges of one of the first side faces 14 (i.e., a rear one of the first side faces 14 in FIG. 7) in the width direction X. The first locking portions 15 each extend from the outer lateral edge of an associated one of the second side faces 16 in the width direction X. The second locking portions 13 each extend from an associated one of the lateral edges of the bottom face 12 in the width direction X. The boundaries between the portions just described are marked with first lines M1, second lines M2, third lines M3, and fourth lines M4. The first to fourth lines M1 to M4 may be created by a “half-cutting process” that involves partially thinning the film F using a tool, such as a punching edge.

As illustrated in FIGS. 7 and 8, the film F according to the present embodiment is provided with three types of thin portions, i.e., first thin portions 19a, second thin portions 19b, and third thin portions 19c. The first thin portions 19a are each provided in the associated second side face 16, the associated first side face 14, the bottom face 12, and the associated second locking portion 13 such that the center of each first thin portion 19a corresponds to a first intersection point N1, which is the intersection of a rear edge 13a of the associated second locking portion 13, the associated first line M1, the associated second line M2, and the associated fourth line M4. The second thin portions 19b are each provided in the associated second locking portion 13, the bottom face 12, and the associated first side face 14 such that the center of each second thin portion 19b corresponds to a second intersection point N2, which is the intersection of a front edge 13b of the associated second locking portion 13, the associated first line M1, the associated fourth line M4, and a lateral edge 14a of the associated first side face 14. The third thin portions 19c are each provided in the associated first locking portion 15 and the associated second side face 16 such that the center of each third thin portion 19c corresponds to a third intersection point N3, which is the intersection of a front edge 15a of the associated first locking portion 15, the associated third line M3, and a front edge 16a of the associated second side face 16. As illustrated in FIG. 8, the first, second, and third thin portions 19a, 19b, and 19c each have a circular or substantially circular shape. The first, second, and third thin portions 19a, 19b, and 19c each have substantially the same radius. Similarly to the lines M1 to M4, the first, second, and third thin portions 19a, 19b, and 19c may be created by a half-cutting process using a tool, such as a punching edge.

The insulation holder 10 according to the present embodiment is formed by folding the film F described above. Specifically, the film F is first folded along the first lines M1. This provides the bottom face 12 having a rectangular shape in the plan view and causes the pair of first side faces 14 to face each other. The first lines M1 after this bending serve as the first edges 10X. The film F is then folded along the second lines M2. This causes the pair of second side faces 16 to face each other so as to form a box shape. The second lines M2 after this bending serve as the third edges 10Z. The film F is then folded along the third lines M3. This provides the first locking portions 15. The first locking portions 15 stop the pair of first side faces 14 from rotating outward (i.e., forward or rearward) in the depth direction Y. The third lines M3 after this bending serve as the third edges 10Z. The film F is then folded along the fourth lines M4. This provides the second locking portions 13. The second locking portions 13 stop the pair of second side faces 16 from rotating rearward. The fourth lines M4 after this bending serve as the second edges 10Y. Through these steps, the film F is folded into the box-shaped insulation holder 10. The first, second, and third thin portions 19a, 19b, and 19c of the insulation holder 10 in finished form overlap one another in its thickness direction. This results in the circular or substantially circular thin portions 19 provided in the areas of the insulation holder 10 including the corners 10C (see FIG. 5).

### 3. Other Embodiments

The preferred embodiment of the present disclosure has been described thus far. The present disclosure is not limited to the embodiment described above but includes other embodiments involving various changes in configuration, structure, or arrangement. The following description discusses other exemplary embodiments of the present disclosure.

### (1) Shape of Thin Portions

As illustrated in FIG. 5, the insulation holder 10 according to the foregoing embodiment is provided with the thin portions 19 each having a circular or substantially circular shape. The shapes of the thin portions, however, are not limited to those in the foregoing embodiment. The thin portions may each have a polygonal shape, such as a quadrangular shape or a triangular shape. The thin portions each having such a shape are also crushed so as to deform the corners inward upon contact between the corners and the case body, making it possible to prevent or reduce breakage of the corners.

(2) Faces in which Thin Portions are Provided

As illustrated in FIG. 5, the thin portions 19 according to the foregoing embodiment are each provided in the bottom face 12, an associated one of the first side faces 14, and an associated one of the second side faces 16. The thin portions, however, are required to be provided in the areas including the corners, which means that each of the thin portions does not necessarily have to be provided in the bottom face, an associated one of the first side faces, and an associated one of the second side faces. In one example, each of the thin portions may be provided in at least one of the bottom face, the first side faces, and the second side faces of the insulation holder. Such an arrangement also causes the thin portions to be crushed so as to deform the corners inward upon contact between the corners and the case body, making it possible to prevent or reduce breakage of the corners. The arrangement of the foregoing embodiment, however, is able to more suitably prevent or reduce breakage of the corners 10C because the thin portions 19 are each provided in the bottom face 12, an associated one of the first side faces 14, and an associated one of the second side faces 16 so as to facilitate deformation of the insulation holder 10.

### (3) Providing Grooves

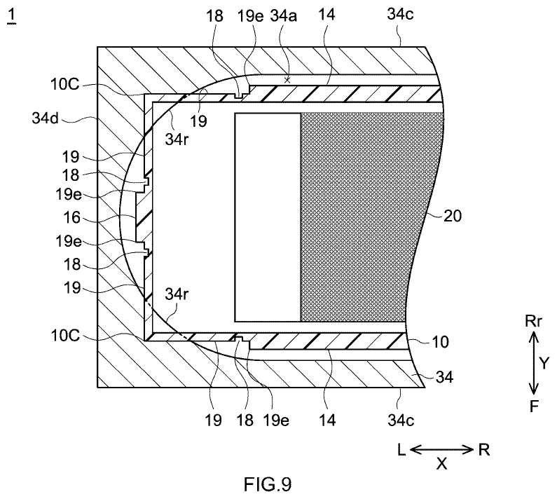

As illustrated in FIG. 9, each thin portion 19 may be provided with a groove 18 such that a region of the thin portion 19 where the groove 18 is provided is thinner than any other region of the thin portion 19. Such an arrangement causes bending of the insulation holder 10 along the grooves 18 in the event of interference between the curved portions 34r of the case body 34 and the corners 10C of the insulation holder 10. This bending further facilitates inward deformation of the corners 10C of the insulation holder 10, making it possible to more suitably prevent or reduce breakage of the corners 10C caused by friction between the corners 10C and the case body 34.

(3) The Number of Areas where Thin Portions are to be Provided

As illustrated in FIG. 4, the number of thin portions 19 provided in the insulation holder 10 according to the foregoing embodiment is four such that each thin portion 19 is associated with one of the four corners 10C. The number of areas where the thin portions are to be provided, however, does not limit the present disclosure and may be changed when necessary. In one example, the position of insertion of the electrode body into the case body may be adjusted such that interference between the case body and the insulation holder occurs only at one of the ends of the secondary battery in the width direction. In this case, the thin portion(s) may be provided such that the thin portion(s) is/are associated with only the corner(s) that interfere(s) with the case body.

Although the preferred embodiments of the present disclosure have been described in detail thus far, these embodiments are presented by way of example only and do not limit the scope of the claims. The techniques described in the claims include various modifications and changes made to the specific examples illustrated above. The present disclosure includes embodiments described in items 1 to 7 below.

### Item 1

An insulation holder that is an insulating box-shaped body to house an electrode body of an electricity storage device, the insulation holder including:
a bottom face having a rectangular shape in a plan view, the bottom face including
   a pair of first edges extending substantially in parallel with each other in a width direction, and
   a pair of second edges extending substantially in parallel with each other in a depth direction;
a pair of first side faces each extending upward in a height direction from an associated one of the first edges;
a pair of second side faces each extending upward in the height direction from an associated one of the second edges;
four third edges each extending in the height direction along a boundary between an associated one of the first side faces and an associated one of the second side faces; and
four corners each of which is an intersection of an associated one of the first edges, an associated one of the second edges, and an associated one of the third edges, wherein
each of the four corners is included in an associated one of four areas defined in the insulation holder, at least one of the four areas being provided with a thin portion thinner than any other portion of the insulation holder.

### Item 2

The insulation holder according to item 1, wherein
the thin portion is provided in the bottom face, an associated one of the first side faces, and an associated one of the second side faces.

### Item 3

The insulation holder according to item 1 or 2, wherein
the thin portion has a thickness of between 10 μm and 100 μm.

### Item 4

The insulation holder according to any one of items 1 to 3, wherein
a shortest distance between the corner included in the at least one of the four areas and an outer edge of the thin portion is between 1 mm and 3 mm.

### Item 5

The insulation holder according to any one of items 1 to 4, wherein
the thin portion is provided with a groove such that a region of the thin portion where the groove is provided is thinner than any other region of the thin portion.

### Item 6

An electricity storage device including:
an electrode body;
a case housing the electrode body; and
an insulation holder located between the electrode body and the case, wherein the case includes
   a case body that is a box-shaped body including an upper opening, and
   a sealing plate closing the upper opening,
the upper opening has a rectangular shape in a plan view, the upper opening including curved portions in four corners of the upper opening, and
the insulation holder is the insulation holder according to any one of items 1 to 5.

What is claimed is:

1. An insulation holder that is an insulating box-shaped body to house an electrode body of an electricity storage device,
the insulation holder comprising:
a bottom face having a rectangular shape in a plan view, the bottom face including a pair of first edges extending substantially in parallel with each other in a width direction, and a pair of second edges extending substantially in parallel with each other in a depth direction;
a pair of first side faces each extending upward in a height direction from an associated one of the first edges;
a pair of second side faces each extending upward in the height direction from an associated one of the second edges;
four third edges each extending in the height direction along a boundary between an associated one of the first side faces and an associated one of the second side faces; and
four corners each of which is an intersection of an associated one of the first edges, an associated one of the second edges, and an associated one of the third edges, wherein
each of the four corners is included in an associated one of four areas defined in the insulation holder, at least one of the four areas being provided with a thin portion thinner than any other portion of the insulation holder.

2. The insulation holder according to claim 1, wherein
the thin portion is provided in the bottom face, an associated one of the first side faces, and an associated one of the second side faces.

3. The insulation holder according to claim 1, wherein
the thin portion has a thickness of between 10 μm and 100 μm.

4. The insulation holder according to claim 1, wherein
a shortest distance between the corner included in the at least one of the four areas and an outer edge of the thin portion is between 1 mm and 3 mm.

5. The insulation holder according to claim 1, wherein
the thin portion is provided with a groove such that a region of the thin portion where the groove is provided is thinner than any other region of the thin portion.

6. An electricity storage device comprising:
an electrode body;
a case housing the electrode body; and
an insulation holder located between the electrode body and the case, wherein
the case includes
a case body that is a box-shaped body including an upper opening, and
a sealing plate closing the upper opening,
the upper opening has a rectangular shape in a plan view, the upper opening including curved portions in four corners of the upper opening, and
the insulation holder is the insulation holder according to claim 1.
